(19) United States
(12) Patent Application Publication
(10) Pub. No.: US 2005/0066756 A1
(43) Pub. Date: Mar. 31, 2005

(54) System for securing a motor transversely to a gearbox

(76) Inventors: Patrick S. Clare, Greenville, SC (US); Larry D. Schafer, Greenville, SC (US); Yogendra K. Sharma, Greenville, SC (US); L. Keith Taliaferro JR., Greenville, SC (US)

Correspondence Address: Alexander M. Gerasimow;Allen-Bradley Company, LLC, 1201 South Second Street, Milwaukee, WI, 53204-2496, US

(21) Appl. No.: 10/675,311

(22) Filed: Sep. 30, 2003

(51) Int. Cl. F16H 1/20

(52) U.S. Cl. 74/423

(57) ABSTRACT

A power system. The system comprises a gearbox. The system may also comprise a motor. The gearbox comprises a gearbox input shaft and a gearbox output shaft. The gearbox output shaft is oriented transverse to the gearbox input shaft. The motor has a motor output shaft. The gearbox has a motor mounting portion to enable the motor to be secured to the gearbox transverse to the gearbox.

### BACKGROUND OF THE INVENTION

1. Field of the Invention

The present invention relates generally to the field of power train systems. More particularly, the invention relates to a novel technique for securing a motor to a gearbox at a right angle relative to the gearbox.

2. Description of the Related Art

A variety of applications exist for systems operable to rotate a shaft. Typically, these systems utilize a motor and a gearbox to rotate the shaft at a desired speed. In industrial applications, for example, gearboxes are commonly employed to convert the rotational speed of an output shaft of a motor to a desired speed of rotation of the shaft. While such gearboxes may be used, inversely, to increase speed of an output shaft as a function of the input shaft rotational speed, they are more commonly employed as speed reducers, coupling a prime mover such as an electric motor or internal combustion engine to a driven application. Depending upon the speed and torque requirements, and the overall speed reduction ratio, speed reducers in industrial applications may include single or multiple stages. Moreover, in most applications the gear ratio of the speed reducer is fixed, with changes in input-to-output ratios being varied by varying the input speed, by gear transmissions, variable-speed sheave drives, and so forth.

In single-stage gear reducers, an input pinion or gear secured to an input shaft or hub meshes with an output gear secured to an output shaft or hub. The gear reduction ratio is defined by the parameters of the input pinion and the output gear in accordance with well established formulae. In multiple-stage gear reduction sets, multiple sets of intermeshing pinions and gears successively reduce speeds of input, intermediate, and output shafts or hubs to obtain a gear reduction ratio which is a product of the reduction ratios of the successive stages.

Power train systems designed for industrial, mining, material handling, and similar applications, are typically configured in one of several designs to accommodate the application requirements, space constraints, and so forth. For example, certain applications may permit a gear reducer to be mounted securely on support feet on a machine frame, while other applications may call for securing the speed reducer directly to an input or output shaft or hub as an overhung load. In one particular product configuration of the latter type, a support housing cover is generally designed to present an output hub or shaft from which the gear reducer itself may be hung. When installed, the gear reducer housing cover is restrained from rotation so as to permit torque to be transferred to the supporting shaft or hub as the input shaft is driven in rotation and the input speed is reduced through the internal gearing.

Conventional designs of power train systems suffer from numerous drawbacks. For example, conventional designs of power train systems typically use a belt to couple the output shaft of a motor to an input shaft of a gearbox. The motor typically is mounted on top of the gearbox. However, belt drive systems require frequent maintenance. In addition, the belt may be dangerous and is typically surrounded by a belt guard. Furthermore, belt drive systems typically are noisy. There is a need, therefore, for an improved power train system to overcome some of the problems associated with belt drive systems.

### BRIEF DESCRIPTION OF THE DRAWINGS

The foregoing and other advantages and features of the invention will become apparent upon reading the following detailed description and upon reference to the drawings in which:

FIG. 1 is a front elevation view of a motive power system, in accordance with an exemplary embodiment of the present invention;

FIG. 2 is a side elevation view of the motive power system of FIG. 1;

FIG. 3 is a cross-sectional view of a portion of the motive power system of FIG. 1;

FIG. 4 is a first cross-sectional view of a gearbox, taken generally along line 4-4 of FIG. 1;

FIG. 5 is an elevation view of the interior of a gearbox, in accordance with an exemplary embodiment of the present invention; and

FIG. 6 is a second cross-sectional view of a gearbox, taken generally along line 6-6 of FIG. 5.

### DETAILED DESCRIPTION OF SPECIFIC EMBODIMENTS

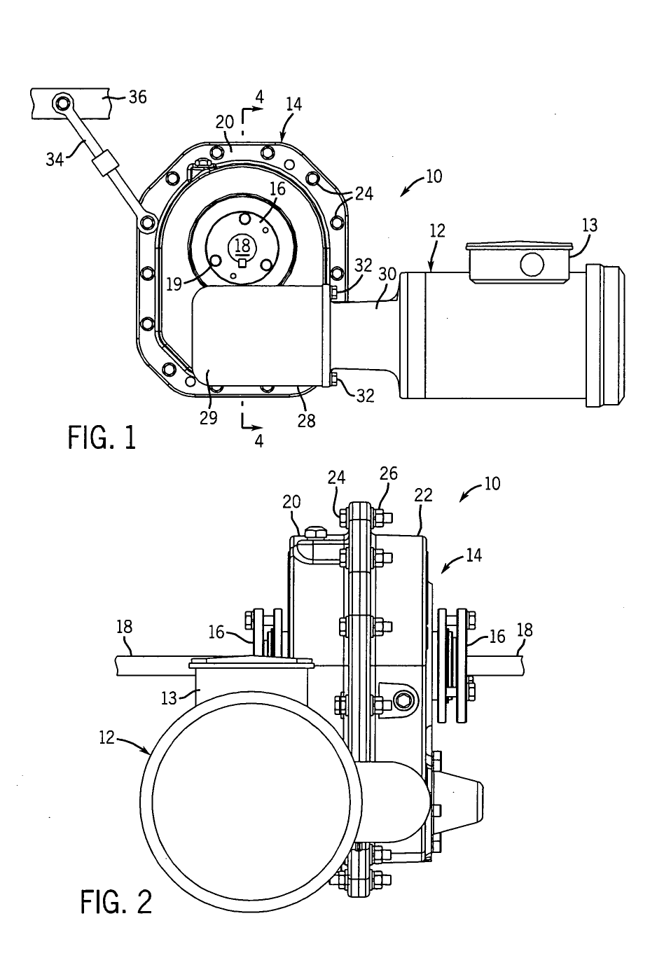

Referring generally to FIGS. 1 and 2, a power train system 10 is illustrated. The illustrated power train system 10 comprises a motor 12. The illustrated motor 12 has a junction box 13 for routing electrical wiring to the motor 12. The motor 12 has an output shaft that rotates at a defined speed. The system 10 also comprises a gearbox 14 that functions as a speed reducer. The output shaft of the motor 12 is drivingly coupled to the speed reducer 14.

In the illustrated embodiment, the speed reducer 14 is coupled to a rotatable shaft 18 disposed through the speed reducer 14. The speed reducer 14 has output bushings 16 on each side that are used to drivingly couple the speed reducer 14 to the rotatable shaft 18. Bolts 19 are used to secure the bushings 16 to the speed reducer 14. The speed reducer 14 has gears that enable the speed reducer 14 to rotate the shaft 18 at a lower rotational speed than the output shaft of the motor 12. However, the present technique also is applicable to gearboxes that are adapted to rotate the shaft 18 at a higher rotational speed than the output shaft of the motor 12.

The motor 12 is secured to the speed reducer 14 at an angle transverse to the shaft 18. In the illustrated embodiment, the motor 12 is secured to a first housing cover 20 of the speed reducer 14. The speed reducer 14 has a second housing cover 22 that is secured to the first housing cover 20 to form a housing. In this embodiment, the first housing cover 20 is secured to the second housing cover 22 by a plurality of bolts 24 and nuts 26. The first housing cover 20 is formed with an input gear housing portion 28 and an input gear housing portion cover 29 disposed over the input gear housing portion 28. A “C-face” adaptor 30 is secured to the motor 12. The adaptor 30, in turn, is secured to the input gear housing portion 28 of the first housing cover 20 to secure the motor 12 to the speed reducer 14. In this embodiment, the adapter 30 is secured to the speed reducer 14 by a plurality of bolts 32.

In the illustrated embodiment, the speed reducer 14 and the motor 12 are supported by the shaft 18. A tie-rod 34 is used to secure the power system 10 to a fixed member 36. The tie-rod 34 acts as a torque arm to ensure that the torque generated by the motor 12 causes the shaft 18 to rotate, rather than causing the system 10 to rotate around the shaft 18. However, the speed reducer 14 and motor 12 may be supported other than by a shaft. For example, the speed reducer 14 may be flange-supported, such as in screw-conveyor systems.

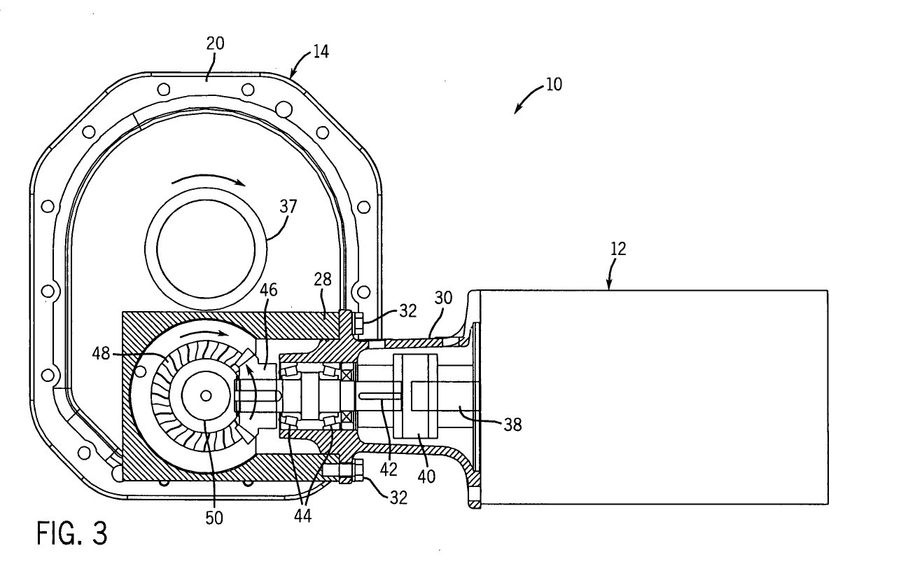

Referring generally to FIG. 3, as noted above, the motor 12 is secured to the speed reducer 14 in a direction transverse to the shaft 18. More specifically, the motor 12 is secured to the speed reducer 14 in a direction transverse to an output shaft 37 of the speed reducer 14. The motor 12 provides power to the speed reducer 14 to induce rotation in the output shaft 37.

In the illustrated embodiment, the motor 12 has an output shaft 38 that is directly coupled by a coupling member 40 to an input shaft 42 of the speed reducer 14. The adapter 30 and the input gear housing portion 28 orient the output shaft 38 of the motor 12 in-line with the input shaft 42 of the speed reducer 14. The input shaft 42 of the speed reducer 14 is supported within the adapter 30 by a pair of bearings 44. A first bevel pinion gear 46 is secured to the input shaft 42. In addition, the first bevel pinion gear 46 is oriented in-line with the output shaft 38 of the motor 12. The output shaft 38 of the motor 12 rotates the input shaft 42 of the speed reducer 14, which, in turn, rotates the first bevel gear 46.

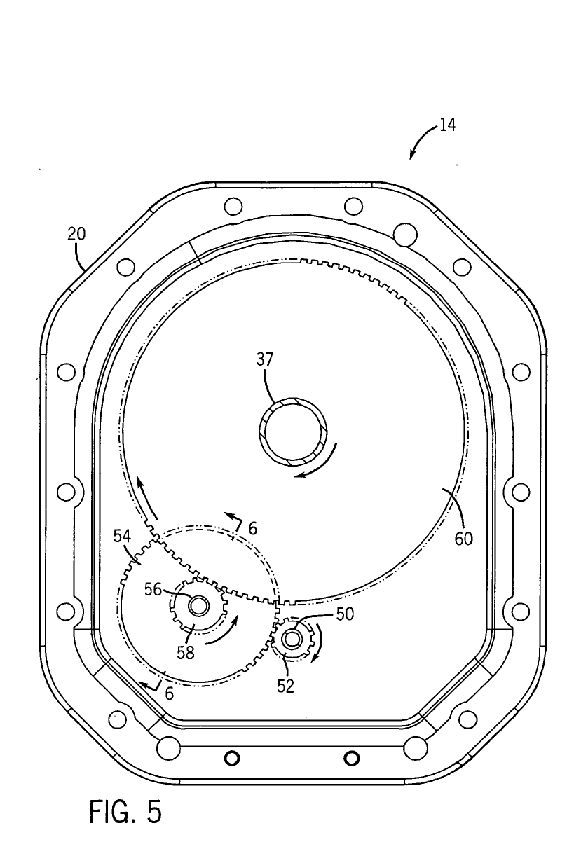

Referring generally to FIGS. 3-6, the speed reducer 14 comprises a plurality of gears that cooperate to reduce the rotational speed of the output shaft 37 of the speed reducer 14 relative to the input shaft 42 of the speed reducer 14. In the illustrated embodiment, the speed reducer 14 also comprises a second bevel gear 48. The first bevel gear 46 is rotates the second bevel gear 48. The second bevel gear 48 is oriented transverse to the first bevel gear 46 and is rotated by the first bevel gear 46. In the illustrated embodiment, the second bevel gear 48 is larger in diameter than the first bevel gear 46. Thus, the second bevel gear 48 rotates at a slower speed relative to the first bevel gear 46. Thus, the first and second bevel gears 46, 48 provide a first stage of speed reduction. However, the first and second bevel gears 46, 48 may have the same diameter. In this case, the first and second bevel gears would not reduce speed. Alternatively, the second bevel gear 48 may be smaller than the first bevel gear 46. In this case, there would be a speed increase from the first bevel gear 46 to the second bevel gear 48. In addition, in the illustrated embodiment, the first bevel gear 46 and the second bevel gear 48 are spiral bevel gears. However, the first and second bevel gears may be threaded in a different configuration, such as a straight bevel configuration.

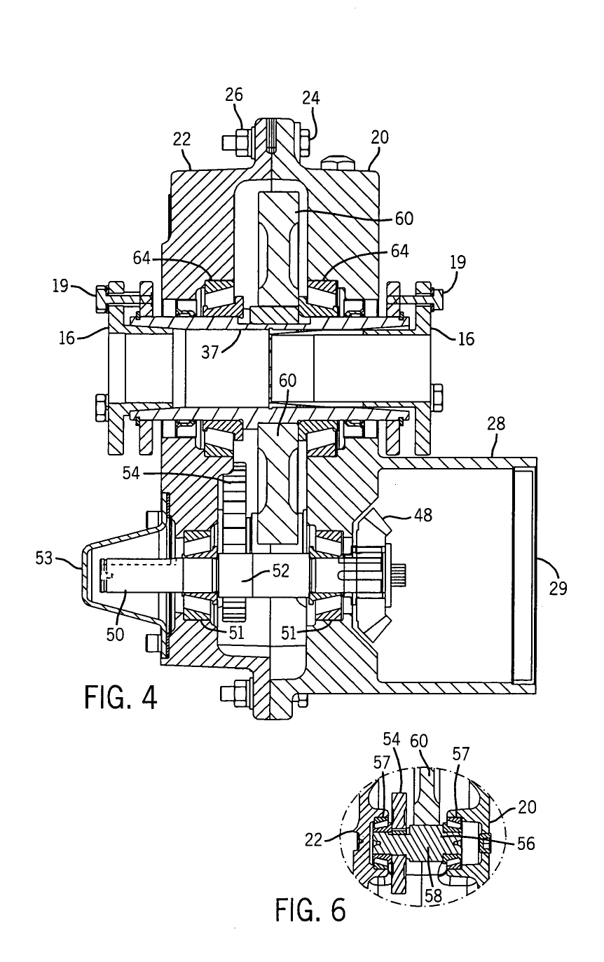

Referring generally to FIGS. 4-6, the second bevel gear 48 of the speed reducer is secured to an intermediate shaft 50 of the speed reducer 14. The intermediate shaft 50 is supported within the speed reducer 14 by a plurality of bearings 51. An intermediate pinion gear 52 is secured to the intermediate shaft 50. The intermediate pinion gear 52 is rotated as the first bevel gear 46 rotates the second bevel gear 48. In the illustrated embodiment, the intermediate shaft 50 extends from the second housing cover 22 to enable a backstop to be attached to the intermediate shaft 50. A backstop limits rotation of the shaft to one direction. A shaft cover 53 is disposed over the end of the intermediate shaft 50 to prevent debris from entering the speed reducer 14.

The speed reducer also comprises an intermediate gear 54 that is secured to an output pinion shaft 56. The output pinion shaft 56 is supported by a plurality of bearings 57. The intermediate gear 54 is rotated by the intermediate pinion gear 52, which, in turn, causes the output pinion shaft 56 to rotate. The intermediate gear 54 is larger than the intermediate pinion gear 52. Thus, the intermediate gear 54 rotates at a slower speed relative to the intermediate pinion gear 52. The intermediate gear 54 and the intermediate pinion gear 52 thereby form a second stage of speed reduction. However, the gears may be sized to maintain speed constant or even to increase the speed of rotation.

The speed reducer also comprises an output gear 60 that is secured to a hollow output shaft 37. The output pinion shaft 56 has an output pinion gear 58 that is operable to drive the output gear 60. The output gear 60 is secured to a hollow output shaft 37. The output shaft 37 is supported by bearings 64. The output gear 60 is larger in diameter than the output pinion gear 58. Thus, the output gear 60 rotates at a slower speed relative to the output pinion gear 58. Thus, the output gear 60 and the output pinion gear 58 provide a third stage of speed reduction. However, the gears may be sized to maintain speed constant or even to increase the speed of rotation.

The output bushings 16 are used to secure the rotatable shaft 18 to the hollow output shaft 37 of the speed reducer. The bushings 16 are wedge-shaped. As the bolts 19 are threaded into the speed reducer 14, the wedge-shaped bushings 16 are driven between the shaft 18 and the hollow output shaft 37 of the speed reducer 14 to produce an interference fit between the shaft 18 and the hollow output shaft 37 of the speed reducer 14. However, other methods of coupling the output of the speed reducer 14 to a rotatable shaft may be used.

The present embodiments provides a power train system that enables a motor 12 to be disposed at a right angle to the output shaft of the system. In addition, the system enables the motor 12 to be coupled directly to the speed reducer. Therefore, no belts are used to couple the motor to the speed reducer. In this orientation, the motor 12 will be less obtrusive.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A system, comprising:
a gearbox, comprising:
a gearbox input shaft;
a gearbox output shaft, the gearbox output shaft being oriented transverse to the gearbox input shaft; and
a motor mounting portion to enable a motor having a motor output shaft to be secured to the gearbox, wherein the motor output shaft is aligned with the gearbox input shaft when the motor is secured to the motor mounting portion.

2. The system as recited in claim 1, comprising the motor.

3. The system as recited in claim 2, wherein the motor comprises a mounting adapter for securing the motor to the motor mounting portion.

4. The system as recited in claim 2, wherein the gearbox comprises a first bevel gear secured to the gearbox input shaft.

5. The system as recited in claim 4, wherein the gearbox comprises a second bevel gear drivingly engaged by the first bevel gear, the first bevel gear being disposed transverse to the second bevel gear.

6. The system as recited in claim 5, wherein the first and second bevel gears are spiral bevel gears.

7. The system as recited in claim 5, wherein the second bevel gear is drivingly coupled to the gearbox output shaft.

8. The system as recited in claim 7, wherein the gearbox is adapted to rotate the gearbox output shaft at a lower speed than the gearbox input shaft.

9. The system as recited in claim 5, wherein the second bevel gear has a larger diameter than the first bevel gear.

10. The system as recited in claim 1, wherein the gearbox is shaft supported.

11. The system as recited in claim 1, comprising a coupling member for coupling the motor output shaft to the gearbox input shaft, wherein the coupling member is disposed in-line with the motor output shaft and the gearbox input shaft.

12. A system, comprising:
a motor having a motor output shaft; and
a gearbox, comprising:
a gearbox input shaft coupled to the motor output shaft, and
a first bevel gear mounted on the gearbox input shaft, wherein the first bevel gear is oriented in-line with the motor output shaft; and
a second bevel gear operable to be rotated by the first bevel gear.

13. The system as recited in claim 12, wherein the first and second bevel gears are spiral bevel gears.

14. The system as recited in claim 12, wherein the second bevel gear is larger in diameter then the first bevel gear.

15. The system as recited in claim 12, wherein the motor output shaft is oriented in-line with the gearbox input shaft.

16. The system as recited in claim 15, wherein the gearbox comprises a motor mounting portion and the motor comprises a mounting adapter securable to the motor mounting portion.

17. The system as recited in claim 12, wherein the gearbox comprises a hollow gearbox output shaft.

18. The system as recited in claim 17, wherein the second bevel gear is drivingly coupled to the hollow gearbox output shaft by at least one gear operable to reduce the speed of the gearbox output shaft relative to the gearbox input shaft.

19. A speed reducer, comprising:
an input shaft;
an output shaft oriented transverse to the input shaft;
a first bevel gear secured to the input shaft; and
a second bevel gear coupled to the output shaft and rotatable by the first bevel gear.

20. The speed reducer as recited in claim 19, wherein the first and second bevel gears are spiral bevel gears.

21. The speed reducer as recited in claim 19, wherein the output shaft is hollow to receive a rotatable shaft therethrough

22. The speed reducer as recited in claim 21, wherein the speed reducer is adapted to be supported by the rotatable shaft.

23. The speed reducer as recited in claim 22, comprising at least one tie-rod securable to a fixed member to prevent the speed reducer from rotating about the rotatable shaft.

24. The speed reducer as recited in claim 19, comprising an output gear, wherein the output shaft is secured to the output gear.

25. The system as recited in claim 24, wherein the second bevel gear is drivingly coupled to the output gear.

26. The speed reducer as recited in claim 19, comprising a first housing cover and a second housing cover, wherein the first housing cover is secured to the second housing cover to form a housing cover for the speed reducer.

27. The speed reducer as recited in claim 26, wherein the first housing cover comprises a mounting bracket extending transverse to the first housing cover, wherein the mounting bracket is operable to secure a motor to the first housing cover.

28. The speed reducer as recited in claim 27, wherein the mounting bracket is operable to align a motor output shaft to the gearbox input shaft.

29. A system, comprising:
a shaft-supportable gearbox having a gearbox output, wherein the gearbox is adapted to secure a motor to the gearbox at a right angle to the gearbox output; and
a torque arm to prevent rotation of the gearbox relative to a shaft.

30. The system as recited in claim 29, comprising a motor securable to the gearbox.

31. The system as recited in claim 29, wherein the gearbox has an input shaft coupleable to a motor output shaft.

32. The system as recited in claim 31, wherein the gearbox comprises a first bevel gear secured to the input shaft and a second bevel gear rotatable by the first bevel gear.
